(19) United States
(12) Patent Application Publication
(10) Pub. No.: US 2005/0108204 A1
(43) Pub. Date: May 19, 2005

(54) System and method for managing OLAP summary tables

(75) Inventor: Mark R. Gordon, Portland, OR (US)

Correspondence Address: HOFFMAN WARNICK & D'ALESSANDRO, LLC, 3 E-COMM SQUARE, ALBANY, NY, 12207, US

(73) Assignee: International Business Machines, Armonk, NY (US)

(21) Appl. No.: 10/712,836

(22) Filed: Nov. 13, 2003

(51) Int. Cl. G06F 17/30

(52) U.S. Cl. 707/3

(57) ABSTRACT

A system and method for managing summary tables. A summary table manager is disclosed for managing summary tables in an OLAP (OnLine Analytical Processing) database system, comprising: a query analysis system that generates a set of proposed summary tables based on query statistics gathered for a set of inputted queries; and a system for calculating a performance measure for each of the proposed summary tables based on the query statistics.

### BACKGROUND OF THE INVENTION

1. Technical Field

The present invention relates generally to OLAP database systems, and more specifically relates to a system and method for proposing and valuing summary tables using query data.

2. Related Art

In an OLAP (OnLine Analytical Processing) database system using star schema to store data, the performance of queries can be improved by creating summary tables (also referred to as aggregates) that contain and are summarized by some, but not all, of the characteristics (dimension table columns used for selection or grouping) or navigation attributes (master data groupings on characteristics) contained in star schema objects (cubes). The summary tables are themselves star schema objects, but contain and are grouped by fewer characteristic and attribute columns than are present in their related cube, and thus have fewer rows. Characteristic is used here to describe any table column used to group or select rows from the cube fact table.

Since a summary table can support queries referencing some or all of its characteristics, it is possible to have a tradeoff between the degree of query optimization, and the number of summary tables. If the characteristics in a summary table exactly match the characteristic columns used in a query, the summary table is fully optimized for that query. If the summary table contains all the characteristic columns used in the query, as well as additional characteristics, then the summary table is partially optimized for the query. Thus, when more distinct summary tables are created, there will be more queries that exactly match the summary tables, and are thus fully optimized. However, adding additional summary tables will use additional disk space, and require more time to maintain and update the summary tables.

Thus, a method is needed to determine sets of characteristics needed to create a group of summary tables that, overall, will provide the largest system-wide performance improvement with the smallest increase in database size.

### SUMMARY OF THE INVENTION

The present invention addresses the above-mentioned problems, as well as others, by providing a system and method for managing summary tables. In a first aspect, the invention provides a summary table manager for managing summary tables in an OLAP (OnLine Analytical Processing) database system, comprising: a query analysis system that generates a set of proposed summary tables based on query statistics gathered for a set of inputted queries; and a system for calculating a performance measure for each of the proposed summary tables based on the query statistics.

In a second aspect, the invention provides a program product stored on a recordable medium for managing summary tables in an OLAP database system, comprising: means for generating a set of proposed summary tables based on query statistics gathered for a set of inputted queries; and means for calculating a performance measure for each of the proposed summary tables based on the query statistics.

In a third aspect, the invention provides a method for managing summary tables in an OLAP database system, comprising: generating a set of proposed summary tables based on query statistics gathered for a set of inputted queries; and calculating a performance measure for each of the proposed summary tables based on the query statistics, wherein the performance measure for each summary table is calculated based on performance data of queries comprising the characteristics in the summary table and performance data for any queries comprising any subsets of characteristics in to the summary table.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an OLAP database system having a summary table manager in accordance with the present invention.

FIG. 2 depicts an original set of query statistics in accordance with the present invention.

FIG. 3 depicts a merged set of query statistics in accordance with the present invention.

FIGS. 4-5 depict query statistics having performance measures for proposed summary tables in accordance with the present invention.

FIGS. 6-8 depict further iterated results in accordance with the present invention.

FIG. 9 depicts performance measures of a proposed summary table for comparative evaluation.

### DETAILED DESCRIPTION OF THE INVENTION

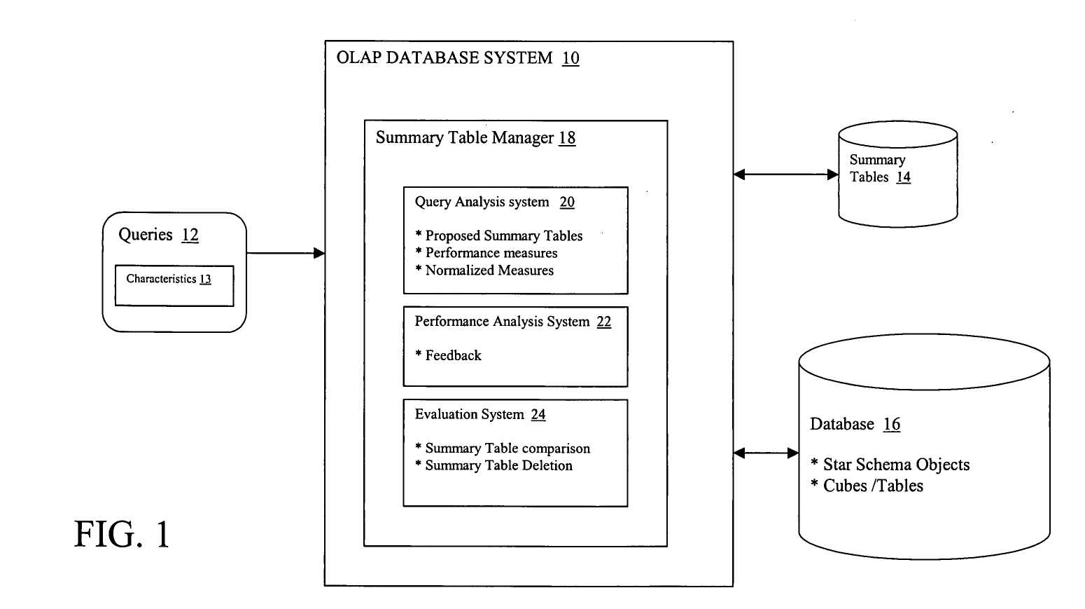

Referring now to the drawings, FIG. 1 depicts an OLAP database system 10 that processes SQL queries 12 to obtain/process data from database 16. OLAP database system 10 can be implemented utilizing any type of computer system having the necessary hardware and software systems to implement the features described below. Database 16 comprises one or more star schema objects (referred to herein as “cubes” or “tables”), which organize data using a set of searching and grouping characteristics, e.g., dates, material figures, locations, etc. A logical cube is made up of a fact table, dimension tables, and master data tables. Fact tables contain information such as count, value, backorder count, allocated count, etc. The fact table index columns have foreign key relationships to dimension tables, which contain the characteristic columns used for grouping/selecting rows from the fact table. Master data tables, which in turn are joined to dimension tables, may contain information about the dimension characteristics, and may be used for grouping (e.g., locations into regions) or selecting the dimension characteristics. Summary tables (also referred to as aggregates) are also star schema objects, but contain and are grouped by fewer characteristic columns than are present in their related cube, and thus have fewer rows. It is assumed for the purposes of this disclosure that the reader is skilled in the art of OLAP database systems. Accordingly, a detailed description of OLAP database systems is not provided.

As noted above, it is a goal of the present invention to determine sets of characteristics needed to create a group of summary tables that, overall, will provide the largest system-wide performance improvement with the smallest increase in database size. To achieve this, an exemplary embodiment is described in which OLAP database system 10 comprises a summary table manager 18 that includes a query analysis system 20, a performance analysis system 22, and an evaluation system 24.

Query analysis system 20 analyzes query data over a period of time and generates a set of proposed summary tables, wherein each proposed summary table is assigned a performance measure. Query analysis system 20 first determines estimated statistical values for each unique query (set of characteristics accessing a specific cube) executed over a time interval. For each unique set of characteristics used by one or more SQL operations, query analysis system 20 calculates the execution count, database time, rows matching predicates (rows selected), and rows transferred after grouping. Then, since a summary table can support an SQL query containing a subset of its characteristics, query evaluation system 20 adds the execution count, database time and rows selected and transferred for all the executed queries using any subset of those characteristics.

Thus, for every unique set of characteristics accessing a specific cube, query analysis system 20 aggregates the performance statistics of all the SQL executions that could have used a summary table whose characteristic columns match that set of characteristics. In the example provided below, each proposed summary table is assigned a “time-size” performance measure, which is a factor of both the estimated time saved by using the proposed summary table and the relative size increase of the proposed data table or cube. A feature of the performance measure is that it is based not only on the particular characteristics of the summary, but also any subsets of those characteristics.

The performance measure can be utilized to prioritize new summary tables corresponding to the different characteristic combinations analyzed, using the degree of grouping in the parent characteristic set to estimate how much the summary table would reduce rows retrieved, and thus estimate the time savings that could be gained by all queries that could use the proposed summary table (i.e., all queries made up of a subset of the characteristics in the summary table).

The information used by query analysis system 20 (characteristics, performance statistics, join conditions for tables that make up cubes, etc.) to obtain the performance measure could be extracted from the OLAP database system 10 (e.g., at SQL execution, or from cached SQL), and/or may also be available via an interface to an application (such as SAP BW) that maintains statistics on query characteristics, query performance statistics, and cube data model.

In addition, as described below, performance of summary tables for different cubes can be “normalized” so that their respective performance can be compared.

Performance analysis system 22 provides a feedback process, wherein queries using identical sets of characteristics are compared before and after the creation of the summary table, and an actual performance improvement is calculated. An example of this calculation is also described below.

Evaluation system 24 examines the performance measures to determine the efficacy of existing and proposed summary tables. Thus, query time savings for a proposed summary table can be estimated and compared to the estimated time savings for another proposed or existing summary table for the same fact cube. Evaluation system 24 may also provide a deletion process, wherein poorly performing or seldom used summary tables are automatically deleted and/or replaced with better performing options.

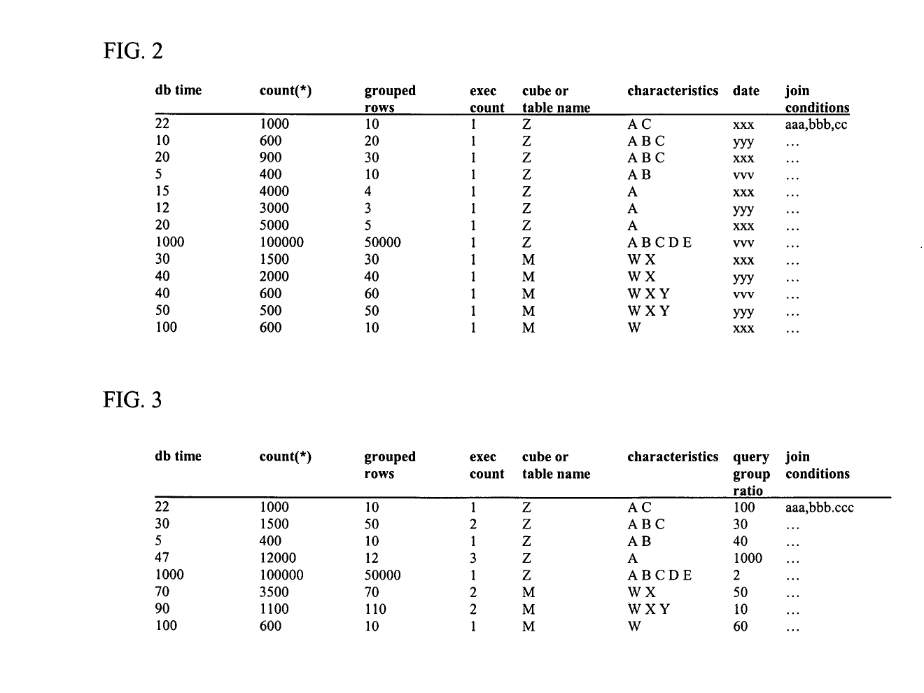

The operation of summary table manager 18 is described in further detail with reference to an example depicted in FIGS. 2-8. As noted above, query analysis system 20 examines query data to generate a list of proposed summary tables and accompanying performance measures. In this exemplary embodiment, the first step is to collect query data for each query executed accessing a star schema object (cube). An example is shown in FIG. 2, wherein the collected query data includes database (db) time, count(*), rows after grouping, execution count, cube or table name, characteristics (chars), date, and join conditions. Count(*) refers to the number of rows in the fact table that satisfy the query predicates.

Note that if the data model for the star schema object is not available to this query evaluation program, then the join conditions used in the SQL would also be saved, in order to build the SQL needed to fill the summary table from the cube. The join conditions are thus an optional column, which would be present or not present in the calculations, based on the environment in which it runs.

The next step is to merge together entries that have the same characteristics (and if join conditions are needed, identical join conditions). The result of this operation is shown in FIG. 3 as a merge array. The “group ratio” column is calculated in order to determine the degree of row summarization done by the grouping. If a summary table were available which was an exact match for the query characteristics, the ratio of count(*) to grouped rows would be 1.

The next step is to identify subsets and incorporate subset information into each query row. This can be done, for example, using the following algorithm:

```
let summary array equal the merge array
for each row in merge array
      for each row in summary array with same query cube as current merged
row
      if set of characteristics in current query row is a subset of the
    characteristics in current summary row
      then add current query row execution count, db time, count(*), and
    grouped rows to corresponding fields in current summary row
            endif
      endfor
endfor
for each row in the summary array
  Ncount = count(*)/group ratio (estimated rows, if the summary table existed, for all
queries that could use it)
  savedtime = db time − (db time * (Ncount/count(*))) (estimate the time savings if
this summary is defined)
endfor
```

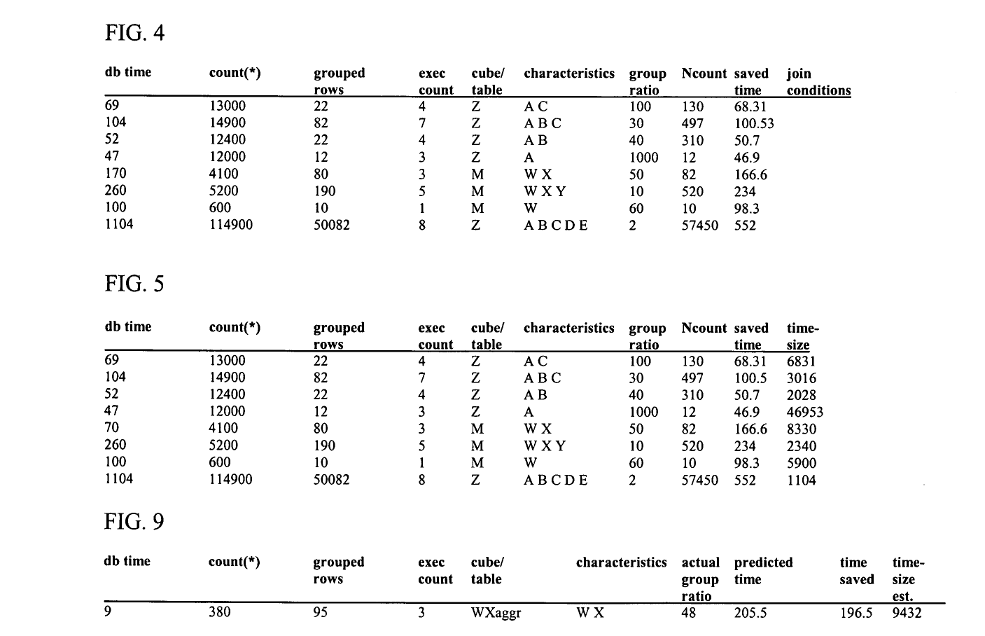

The result of this algorithm is shown in FIG. 4, wherein each row entry represents a proposed summary table (e.g., using the characteristic sets A C, A B C, etc.), and includes a performance measure comprising an estimated amount of query time that will be saved by using the summary table.

The proposed summary tables can be further evaluated by providing a time-size performance measure that would determine an estimated benefit, based on both the estimated query time savings and the estimated space of the summary table in relation its fact table size. Such a performance measure is shown in FIG. 5 and provides the performance benefit by the size of the summary table compared to the fact table. For two summary tables based on the same fact table, a proposed summary table which would save 50 seconds of db time with a 100 group ratio (50 seconds saved for a 1% increase in the DB) is time-size equal to an summary table which would save 100 seconds of db time with a 50 group ratio (100 seconds for a 2% increase in the DB). The time-size is useful to avoid creating proposed summary tables that will support many characteristic combinations, but which are very large.

As shown in FIG. 5, “A” and “WX” are the characteristics contained in the two proposed summary tables with the best time-size value for the two query cubes. They are chosen on this pass, their predicted values are saved, and the predicted time savings ratio can be calculated from the inverse of the query grouping ratio.

| | chars | | | | |
|---|---|---|---|---|---|
| summary | time savings | | | predicted | |
| table | ratio | | grouping | ratio | |
| Aaggr | | A | | 1000 | |
| | 0.001 | | | | |
| WXaggr | W X | | 50 | | 0.02 |

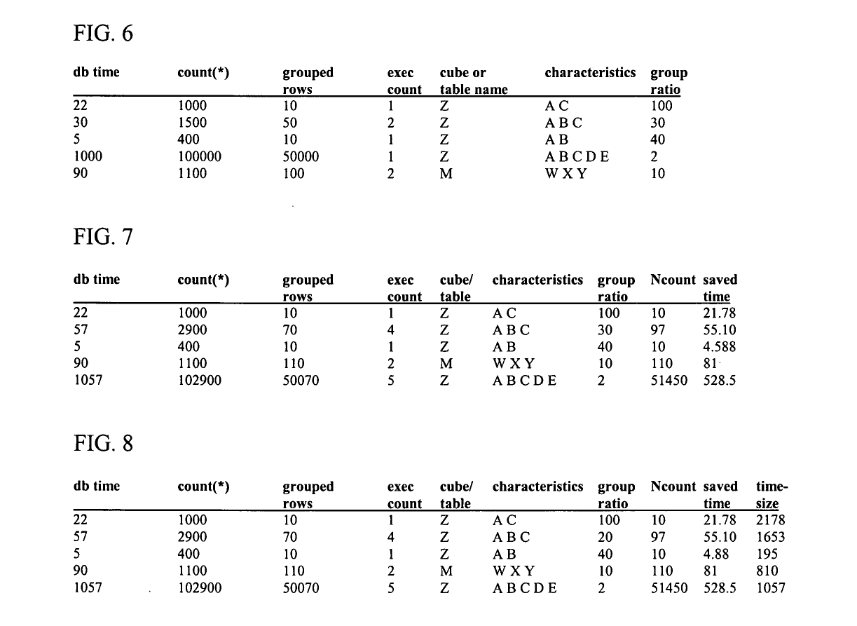

The process shown in FIG. 3-5 must then be repeated/iterated such that the query statistics for queries matching the characteristics in the chosen summary tables (“A” and “W X”) are removed along with the query statistics for queries using subsets of the chosen characteristics (“W” in this example). This is required in this exemplary embodiment since the queries made up of subsets of characteristics can be executed on the proposed summary tables, and were part of determining the time-size value of the summary table. The value of the remaining characteristic combinations must therefore be recalculated to evaluate additional possible summary tables. The results of the next (i.e., second) iteration are shown in FIGS. 6-8. On this second iteration, “A C” and “W X Y” are the best proposals for the two query cubes. The process can be iterated until all characteristic combinations are processed.

Since the performance measure “time-size” is based on a grouping ratio, proposed summary tables for different cubes cannot be directly compared. Accordingly, a method is needed to normalize the performance measures, regardless of the fact table used as a starting point. One exemplary method is to determine “saved time per MB” during the measurement interval for each proposed summary table in order to evaluate the benefit of summary tables for different fact tables. The first step is to obtain the size of the fact table for the query cube from the database catalog, as follows:

| query | |
|---|---|
| cube | MB |
| Z | 1000 |
| M | 2000 |

Next, the statistics described above are generated as follows:

| | | | group | |
|---|---|---|---|---|
| | | | saved time | |
| | chars | | ratio | |
| query | time-size | predicted MB | per mb | saved |
| cube | estimate | of aggregate | estimate | time |
| Z | A | | 1000 | 46.9 |
| | 46900 | | 1 | 46.9 |
| Z | A C | | 100 | 19.8 |
| | 1980 | | 10 | 1.98 |
| M | W X | | 50 | 166 |
| | 8330 | | 40 | 4.15 |
| M | W X Y | | 10 | 81 |
| | 810 | | 200 | 0.4 |

Depending on the goals of the summary table manager 18, summary tables could be chosen starting from the highest “saved time per mb,” which yields the most improvement for the least space, or summary tables could also be chosen based on “saved time,” in order to provide the largest improvement in query performance, though at a larger cost in space. If queries on certain fact tables are considered more important to the business than others, then summary tables could be created only for that fact table.

In addition, by summing the estimated saved time and group ratio, this method can be used to estimate the amount of space required to achieve a specific improvement in performance. For example, if P is the sum of the database time for all queries in a measurement interval, and Q is the size of all fact tables, then after summary table A is created, estimated database time would be (P−46.9) seconds, and estimated database size would be (Q+1) MB. After A and WX are created, the estimated database time would be (P−46.9−166) seconds, and estimated database size would be ((Q+1+40) MB, etc.

In addition, summary table manager 18 includes a performance analysis system 22, which determines the actual performance value of a given summary table using feedback from OLAP database system 10. Specifically, by comparing the statistics for queries using identical characteristics, before and after the creation of a summary table, one can determine the actual performance improvement. For example, consider the following query data.

| | count(*) | grouped | | | |
|---|---|---|---|---|---|
| db | chars | date | | query | |
| time | count | cube | exec | rows | |
| 30 | | 1500 | | 30 | |
| | 1 | M | | W X | xxx |
| 40 | | 2000 | | 40 | |
| | 1 | M | | W X | xxx |
| 100 | | 10000 | | 10 | |
| | 1 | M | | W | xxx |
| 2 | | 35 | | 35 | |
| | 1 | WXaggr | W X | zzz | |
| 1 | | 20 | | 20 | |
| | 1 | WXaggr | W X | zzz | |
| 4 | | 300 | | 15 | |
| | 1 | WXaggr | W | zzz | |

For the characteristic set “W X,” queries executed against M take one second per grouped row (30+40/30+40), while the queries using Wxaggr take 0.054 seconds per row ((1+1/35+20). Thus, the reduction in time is 0.054/1=0.054.

For characteristic set “W,” queries executed against M take 10 seconds per grouped row (100/10), while queries using WXaggr take 0.26 seconds per row, thus the reduction in time is 0.26/10=0.026.

Using query statistics for all characteristic combinations from the summary table, the weighted summary table benefit can be calculated as: Actual time savings ratio=sum of ((execution count for set of characteristics*improvement)/total executions using summary table), or ((2*0.054)/3)+((1*0.026/3)=0.044.

Using the predicted values from summary table creation then gives:

| | chars | | | | |
|---|---|---|---|---|---|
| | actual | | | | validity |
| summary | date | predicted | predicted | actual time | savings |
| table | ratio | grouping | grouping | time savings | ratio |
| Aaggr | | A | 1000 | | 0.001 |
| WXaggr | W X | 50 | | 0.02 | |
| | 0.044 | | mmm | | 48 |

Thus, WXaggr is only about half as valuable as estimated. This could be utilized as a factor in determining whether or not to keep this summary table. In addition, actual grouping can be determined by comparing the cardinality of the summary table and the fact table that it is based on.

Finally, summary table manager 18 may include an evaluation system 24 that can automatically remove low performing summary tables. Specifically, in a system where summary tables have been defined, the query statistics can be used to determine whether a summary table should be kept. The time-size value of a deletion candidate can be calculated, and compared to the time-size value of a proposed summary table (shown above) using the same fact table. Consider the following example in which the query statistics:

| | count(*) | | | | |
|---|---|---|---|---|---|
| | chars | grouped | exec | cube/ | |
| db time | count | table | date | rows | |
| 4 | | 70 | | 70 | |
| | 1 | WXaggr | W X | | zzz |
| 1 | | 10 | | 10 | |
| | 1 | WXaggr | W X | | zzz |
| 4 | | 300 | | 15 | |
| | 1 | WXaggr | W | | zzz |

are merged to yield:

| | count(*) | | | | |
|---|---|---|---|---|---|
| | chars | | | | |
| | count | grouped | exec | cube/ | |
| db time | ratio | table | group | rows | |
| 5 | | 80 | | 80 | |
| | 2 | WXaggr | W X | | 1 |
| 4 | | 300 | | 15 | |
| | 1 | WXaggr | W | | 20 |

Then, as described above, statistics can be rolled up with the characteristics in the summary table. Use the actual time savings ratio (calculated above for Wxaggr as 0.044) to estimate how long the queries would run without the summary table. (DB time using using summary)/(time savings ratio) gives the predicted time without using the summary table. For example, see FIG. 9 where Wxaggr db time/0.044 yields a predicted time estimate without summary table of 205.5. Then as shown in FIG. 9, (predicted time without summary table−db time using summary table) yields “time saved,” which is used in the formula (grouping*time saved) to calculate a timesize value for deleting the summary table, which can be compared to timesize value calculated for adding a summary table in FIG. 5 or FIG. 8.

This yields a time-size value for delete operations that can be compared with the time-size value for summary table definitions to determine whether it is better to keep this summary table, or drop it and define a different summary table on the same cube.

Likewise, “time saved per MB” can be calculated for the summary table, to place it in an ordered list to compare a summary table deletion candidate from one fact table with a summary table creation candidate from another fact table.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A summary table manager for managing summary tables in an OLAP (OnLine Analytical Processing) database system, comprising:
a query analysis system that generates a set of proposed summary tables based on query statistics gathered for a set of inputted queries; and
a system for calculating a performance measure for each of the proposed summary tables based on the query statistics.

2. The summary table manager of claim 1, wherein the set of proposed summary tables is determined based on characteristics utilized in the set of inputted queries.

3. The summary table manager of claim 1, wherein the performance measure comprises an estimated amount of time saved for using the summary table.

4. The summary table manager of claim 1, wherein the performance measure is based on a combination of time saved and summary table size.

5. The summary table manager of claim 1, wherein the performance measure for each summary table is calculated based on performance data of characteristics relating to the summary table and performance data for any subsets of characteristics relating to the summary table.

6. The summary table manager of claim 1, further comprising a system for normalizing performance measures determined for summary tables that are based on different fact tables.

7. The summary table manager of claim 1, further comprising a performance analysis system that determines an actual performance value of a given summary table using feedback from the OLAP database system.

8. The summary table manager of claim 7, wherein the performance analysis system compares statistics for queries using identical characteristics that are obtained before and after creation of a summary table.

9. The summary table manager of claim 1, further comprising an evaluation system that automatically deletes low performing summary tables.

10. A program product stored on a recordable medium for managing summary tables in an OLAP (OnLine Analytical Processing) database system, comprising:
means for generating a set of proposed summary tables based on query statistics gathered for a set of inputted queries; and
means for calculating a performance measure for each of the proposed summary tables based on the query statistics.

11. The program product of claim 10, wherein the set of proposed summary tables is determined based on characteristics utilized in the set of inputted queries.

12. The program product of claim 10, wherein the performance measure comprises an estimated amount of time saved for using the summary table.

13. The program product of claim 10, wherein the performance measure is based on a combination of time saved and summary table size.

14. The program product of claim 10, wherein the performance measure for each summary table is calculated based on performance data of characteristics relating to the summary table and performance data for any subsets of characteristics relating to the summary table.

15. The program product of claim 10, further comprising means for normalizing performance measures determined for summary tables that are based on different fact tables.

16. The program product of claim 10, further comprising means for determining an actual performance value of a given summary table using feedback from the OLAP database system.

17. The program product of claim 16, wherein the determining means compares statistics for queries using identical characteristics that are obtained before and after the creation of a summary table.

18. The program product of claim 10, further comprising means for automatically deleting low performing summary tables.

19. A method for managing summary tables in an OLAP (OnLine Analytical Processing) database system, comprising:
generating a set of proposed summary tables based on query statistics gathered for a set of inputted queries; and
calculating a performance measure for each of the proposed summary tables based on the query statistics, wherein the performance measure for each summary table is calculated based on performance data of characteristics relating to the summary table and performance data for any subsets of characteristics relating to the summary table.

20. The method of claim 19, wherein the step of generating the set of proposed summary tables is determined based on characteristics utilized in the set of inputted queries.

21. The method of claim 19, wherein the performance measure comprises an estimated amount of time saved for using the summary table.

22. The method of claim 19, wherein the performance measure is based on a combination of time saved and summary table size.

23. The method of claim 19, comprising the further step of normalizing performance measures determined for summary tables that are based on different fact tables.

24. The method of claim 19, comprising the further step of determining an actual performance value of a given summary table using feedback from the OLAP database system.

25. The method of claim 24, wherein the step of determining the actual performance value compares statistics for queries using identical characteristics that are obtained before and after the creation of a summary table.

26. The method of claim 19, comprising the further step of automatically deleting low performing summary tables.
